(19) United States
(12) Patent Application Publication
(10) Pub. No.: US 2011/0068976 A1
(43) Pub. Date: Mar. 24, 2011

(54) METHOD AND APPARATUS FOR ACCELERATING THE PROCESS OF DETERMINING A GEOGRAPHIC POSITION

(75) Inventors: CHAMINDA BASNAYAKE, WINDSOR (CA); SETHU K. MADHAVAN, CANTON, MI (US); ERAY YASAN, CANTON, MI (US)

(73) Assignees: GM GLOBAL TECHNOLOGY OPERATIONS, INC., DETROIT, MI (US); GENERAL MOTORS COMPANY, DETROIT, MI (US)

(21) Appl. No.: 12/563,496

(22) Filed: Sep. 21, 2009

(51) Int. Cl. G01S 19/05

(52) U.S. Cl. 342/357.42

(57) ABSTRACT

Methods and apparatus are provided for accelerating the process of determining a geographic position. The method includes, but is not limited to activating a satellite navigation device that is configured to receive a satellite communication signal and to receive a wireless communication signal. The method also includes receiving the wireless communication signal from a local portable wireless device using the satellite navigation device. The wireless communication signal contains satellite related data. The method also includes calculating, with the satellite navigation device, the geographic position of the satellite navigation device using the satellite related data received from the portable wireless device.

### TECHNICAL FIELD

The technical field generally relates to determining a geographic position, and more particularly relates to determining the geographic position using a satellite navigation device.

### BACKGROUND

Satellite navigation devices, such as, but not limited to, those which are compatible with the Global Positioning Satellite (GPS) navigation system are increasingly common in the marketplace. Some satellite navigation devices are available as an option on many models of automotive vehicles. These satellite navigation devices are typically permanently installed in a vehicle's instrument panel. Additionally, there are multiple after-market satellite navigation devices that are available for purchase and which serve a wide variety of purposes. Some are configured to be mounted within the passenger compartment of a vehicle to assist a driver in reaching a destination. Other satellite navigation devices are portable and may be used for a variety of activities such as pedestrian navigation, hiking, fishing, hunting, skiing, mountain climbing, etc. . . . Still others are configured to be used in conjunction with the operation of marine craft and other types of vehicles.

Satellite navigation devices are configured to receive satellite communication signals transmitted by satellites orbiting the earth. These orbiting satellites transmit satellite communication signals which contain information that can be used by the satellite navigation devices to determine the position of the satellite navigation device on the surface of the earth (their “geographic position”).

In one example, the GPS Navigation System (official name—NAVSTAR GPS) includes a constellation of over 24 satellites. Each satellite in the constellation transmits a satellite communication signal that contains navigation data, some of which is divided into two categories. The first category of navigation data, “ephemeris data”, contains precise orbital information pertaining to the transmitting satellite. The second category of navigation data, the “almanac”, contains information relating to the general system health and rough orbits of all the satellites in the constellation.

The ephemeris data is updated regularly as the satellite orbits the earth. If the satellite navigation device is switched off or is otherwise out of communication with the GPS satellites for a period of longer than a particular time window (hereinafter, the “ephemeris update interval”), which in most instances is two hours, then the ephemeris data stored in the satellite navigation device will not be current. Current ephemeris data is then be downloaded from the satellites in order for the satellite navigation device to be able to calculate its current geographic position.

The process of downloading current ephemeris data from the constellation of satellites generally takes approximately thirty seconds. The satellite navigation device must typically have a generally unobstructed exposure to the satellites for this thirty second period in order to acquire the ephemeris data. If, while downloading the ephemeris data, the signal is disrupted or obstructed, the process of downloading the ephemeris data may begin anew which restarts the thirty second time period. If this happens multiple times, the time required to obtain the ephemeris data can stretch out to a few minutes or longer, depending on the number of times that the satellite communication signal's transmission is disrupted. Similar interruptions may occur in noisy or weak signal environments such as urban areas with lots of reflection surfaces or tree covered areas. During this period of time, the satellite navigation device may be unable to provide navigation assistance. Depending upon a person's desire for navigation assistance, a delay of between thirty seconds to several minutes before receiving navigation assistance may be inconveniently long.

Accordingly, it is desirable to reduce the amount of time required by a satellite navigation device to receive current ephemeris data after having been switched off or otherwise out of communication with the satellites for more than the ephemeris data update interval. Furthermore, other desirable features and characteristics will become apparent from the subsequent detailed description and the appended claims, taken in conjunction with the accompanying drawings and the foregoing technical field and background.

### SUMMARY

A method and an apparatus are provided for accelerating the process of determining a geographic position. In a first, non-limiting example, the method includes, but is not limited, to activating a navigation device that is designed and constructed to receive a satellite communication signal and a wireless communication signal. The method further includes receiving the wireless communication signal from a local portable wireless device with the navigation device. The wireless communication signal contains satellite related data. The method also includes calculating, with the navigation device, the geographic position of the navigation device using the satellite related data from the portable wireless device.

In a second, non-limiting example, the method includes, but is not limited to, activating a navigation device that is mounted in a first vehicle. The navigation device is configured to receive a satellite communication signal and a wireless communication signal. The method further includes receiving the wireless communication signal from a second vehicle with the navigation device. The wireless communication signal contains satellite related data. The method also includes calculating, with the navigation device, the geographic position of the navigation device using the satellite related data from the second vehicle.

In a third, non-limiting example, a navigation device is provided for determining a geographic position. The navigation device includes, but is not limited to a housing and an electronic processing device that is mounted within the housing and that is configured to calculate the geographic position of the navigation device using satellite related data. The navigation device also includes a satellite communication signal receiver that is communicatively coupled to the electronic processing device and that is configured to receive multiple satellite communication signals from respective multiple satellites. The multiple satellite communication signals contain the satellite related data. The navigation device further includes a wireless communication signal receiver that is communicatively coupled to the electronic processing device and that is configured to receive a wireless communication signal containing the satellite related data. In this third example, the electronic processing device is configured to calculate the geographic position of the navigation device using the satellite related data received via the wireless communication signal.

### DESCRIPTION OF THE DRAWINGS

One or more examples will hereinafter be described in conjunction with the following drawing figures, wherein like numerals denote like elements, and

FIG. 1 is a schematic view illustrating an arrangement for receiving satellite related data from orbital satellites needed to calculate a geographic position;

FIG. 2 is a schematic view illustrating a non-limiting example of a satellite navigation device configured to receive satellite related data via a wireless communication signal;

FIGS. 3-4 are schematic views illustrating non-limiting implementations of the satellite navigation device of FIG. 2; and

FIGS. 5-6 are flow charts illustrating non-limiting examples of the methods disclosed herein.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

As used herein, the term “wireless communication” refers to the transfer of information over a distance without the use of electrical conductors or wires. Non-limiting examples of devices which engage in wireless communicate include, but are not limited to, fixed, mobile and portable two way radios, cellular and other types of mobile telephones, personal digital assistants (PDAs) and wireless networking such as 802.11 LAN (http://www.ieee802.org/11/) and 802.15 WPAN (http://www.ieee802.org/15/). Other examples include garage door openers, wireless computer mice, keyboards, cordless telephones and wireless telephone head sets.

As used herein, the term “wireless communication signals” refers to signals, other than satellite communication signals, that are used to conduct wireless communication. Such signals include, but are not limited to, radio frequency (RF) signals including, without limitation, DSRC signals. Wireless communication signals may also include Infra Red signals and Bluetooth signals.

As used herein, the term “satellite navigation device” refers to any device that receives satellite communication signals and that is configured to use the information communicated by such signals to determine the present geographic location of the device.

As used herein, the term “portable wireless device” refers to any hand held or transportable device that is configured to engage in wireless communications. Such devices include, but are not limited to, fixed, mobile and portable two way radios, cellular and other types of mobile telephones, personal digital assistants (PDAs) and wireless networking such as 802.11 LAN (http://www.ieee802.org/11/) and 802.15 WPAN (http://www.ieee802.org/15/). Other examples include garage door openers, wireless computer mice, keyboards, cordless telephones and wireless telephone head sets.

As used herein, the term “local portable wireless device” refers to a portable wireless device that is located near enough to a satellite navigation device to be able to engage in wireless communications with the satellite navigation device.

As used herein, the term “DSRC” refers to one-way or two-way short to medium range wireless communication channels specifically designed for automotive use and a corresponding set of protocols and standards. DSRC is an acronym which stands for dedicated short range communications. DSRC offers communication between the vehicle and roadside equipment and between the vehicle and another vehicle.

As used herein, the term “ephemeris data” refers to data which contains substantially precise orbital information, onboard clock information, system health information, and atmospheric information pertaining to a satellite transmitting the ephemeris data and with which a satellite navigation device is enabled to determine its geographic position on the surface of the earth.

As used herein, the term “satellite related data” refers to any data relating to the satellites of the Global Positioning Satellite Navigation System or to the satellites of any other global navigation satellite system (GNSS), which data may be used by a satellite navigation device to determine its geographic position on the surface of the earth. Examples of satellite related data include ephemeris data and almanac data.

There are an increasing number of portable wireless devices in the marketplace today that include a GPS chipset or which are otherwise configured to interact with the GPS navigation system so that the a geographic position of the portable wireless device can be determined. A common non-limiting example of such a portable wireless device is a cellular telephone. Such portable wireless devices, when switched on or activated, receive the ephemeris data from the GPS satellites or from another source such as a wireless carrier network. These devices maintain the ephemeris data while they remain switched on. It is common practice for persons carrying cellular telephones to leave them on.

By configuring satellite navigation devices to engage in wireless communication, these satellite navigation devices can wirelessly communicate with portable wireless devices and can download the ephemeris data directly from these portable wireless devices. For example, a satellite navigation device mounted in a vehicle may wirelessly communicate with the cellular telephone of the driver when the driver turns the vehicle on or when the driver activates the satellite navigation device. In other examples, the satellite navigation device may wirelessly communicate with the cellular telephone of nearby pedestrians or other motorists to obtain the ephemeris data.

Additionally, a satellite navigation device configured to engage in wireless communication can also receive the ephemeris data from another satellite navigation device that is also configured to engage in wireless communication. For example, vehicles equipped with satellite navigation devices that are traveling down the same road may communicate with one another to provide/receive the ephemeris data.

In this manner, the need for a fixed number of seconds of unobstructed exposure to satellites, commonly known as the “cold or warm start start-up time” may be avoided. Instead, the satellite navigation device can obtain the ephemeris data needed to calculate its position in just a few seconds. A greater understanding of the examples of the methods and apparatus disclosed herein may be obtained through a review of the illustrations accompanying this disclosure together with a review of the detailed description that follows.

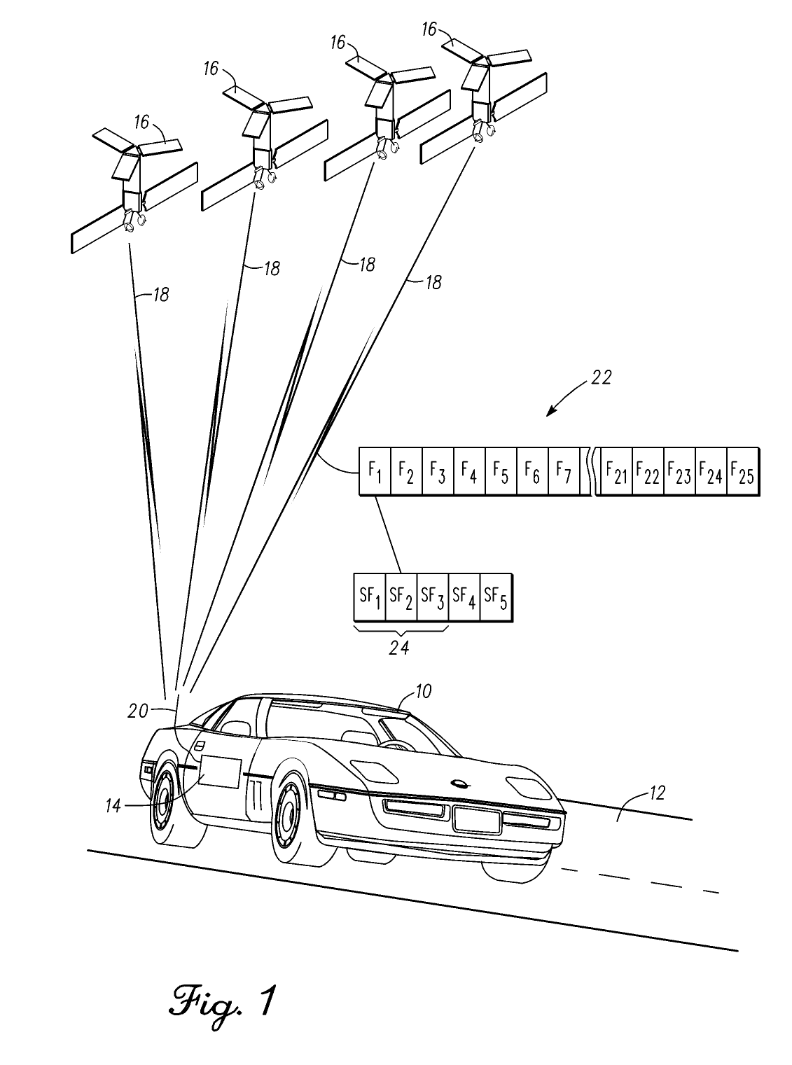

With respect to FIG. 1, a system for determining a geographic position using data provided by orbital satellites is illustrated. A vehicle 10 is being operated on road 12. Vehicle 10 may be any type of vehicle including, without limitation, a passenger car, a truck, a motor cycle, a bicycle, a motor bike, a recreational vehicle, an all terrain vehicle, and/or a bus. In other examples, vehicle 10 may include, without limitation, a marine vehicle, a water craft, a rail driven vehicle and a hover craft. In FIG. 1, vehicle 10 is equipped with a prior art satellite navigation device 14.

A plurality of satellites 16 orbit above the earth and transmit a satellite communication signal 18 which is detectible on the surface of the earth. In the illustrated example, satellites 16 are associated with the GPS Navigation System and constitute a portion of the satellite constellation that comprises the GPS Navigation System. While the context of the discussion contained herein is with reference to the GPS Navigation System, it should be understood that the teachings of the present disclosure are not limited to use with the GPS Navigation System, but are equally applicable to other satellite based navigation systems, whether now known, in existence, or hereafter developed.

In the illustrated system, each satellite communication signal 18 is appropriately modulated to contain information relating to the location of the transmitting satellite as well as information relating to the entire constellation of satellites. Vehicle 10 includes a satellite antenna 20 which is configured to receive satellite communication signals 18. Prior art satellite navigation device 14 is configured to utilize the satellite related data to determine its geographic position.

Satellite related data 22, which constitutes the satellite related data transmitted by satellites in the GPS Navigation System, is illustrated in FIG. 1. Satellite related data 22 is divided into 25 segments or frames. Each frame is divided into five segments or sub-frames. The first three sub-frames of each frame contain ephemeris data 24 which includes the ephemeris data relating to the transmitting satellite. Prior art satellite navigation device 14 is configured to utilize ephemeris data 24 to calculate the geographic position of prior art satellite navigation device 14 and, by extension, vehicle 10.

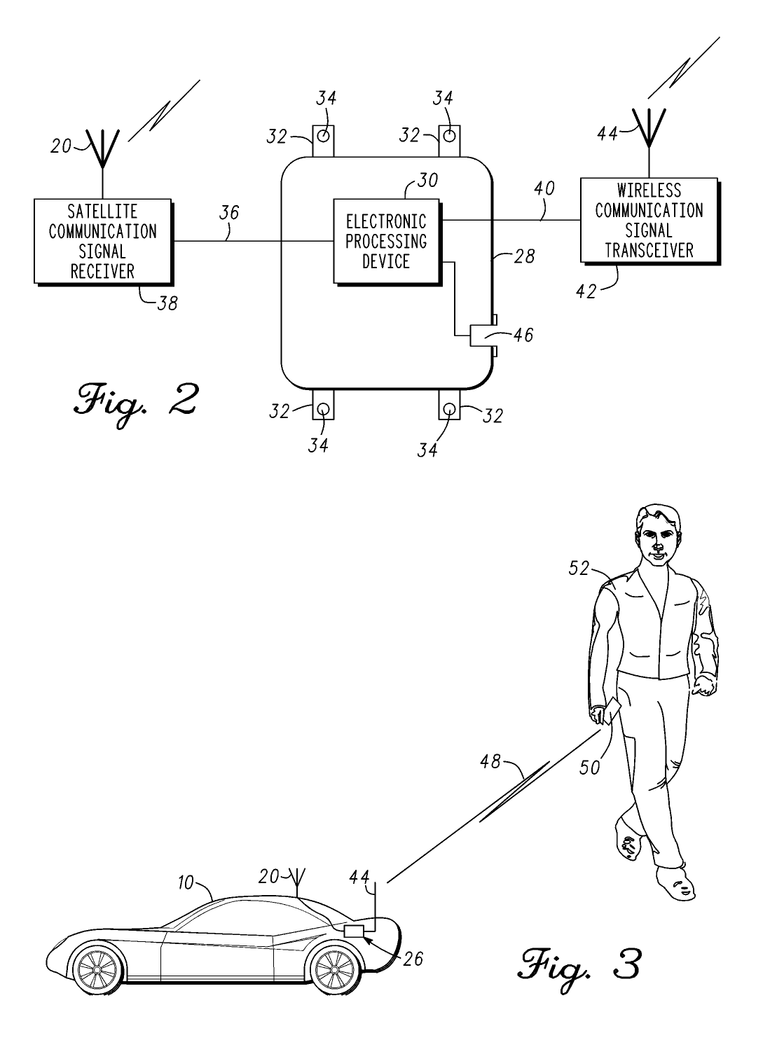

With respect to FIG. 2, a non-limiting example of a satellite navigation device 26 configured to obtain satellite related data from another source in addition to orbital satellites is schematically depicted. Satellite navigation device 26 may be integrally mounted in an instrument panel or other component of vehicle 10. In other examples, satellite navigation device 26 may be an after-market device purchased independently from vehicle 10 and may be mountable to, and removable from, an interior surface of vehicle 10.

In other examples, satellite navigation device 26 may be a hand held unit that is portable and used by pedestrians or by other persons engaged in activities that do not involve the operation of a vehicle.

In the illustrated example, satellite navigation device 26 includes a housing 28 and an electronic processing device 30 mounted within the housing 28. Housing 28 may be made of any suitable material including, but not limited to, plastic materials and metal materials. Housing 28 includes tabs 32 which may be integrally formed with housing 28 or which may be separately fabricated and attached by any means effective to form a robust attachment between tabs 32 and housing 28. Tabs 32 include an opening 34 to permit a fastener, such as a threaded fastener to pass through opening 34. Tabs 32 permit housing 28 to be mounted within an instrument panel, or elsewhere, in vehicle 10. In other examples, housing 28 does not include tabs 32.

Electronic processing device 30 may be any suitable computer, microprocessor or the like that is configured to execute software applications and/or subroutines. Electronic processing device 30 includes, or has access to, software applications that enable electronic processing device 30 to utilize satellite related data to calculate the geographic position of satellite navigation device 26.

Electronic processing device 30 is communicatively connected via lead or bus 36 to a satellite communication signal receiver 38 which, in turn, is connected to satellite antenna 20. Satellite communication signal receiver 38 is configured to receive and demodulate satellite communication signals, including satellite communication signal 18. Satellite communication signal receiver 38 is further configured to send the demodulated signals to electronic processing device 30 which may then extract satellite related data. In other embodiments, satellite communication receiver 38 may include a dedicated electronic processing device which is configured to extract the satellite related data from satellite communication signal 18 and then forward the satellite related data to electronic processing device 30.

Although the example illustrated in FIG. 2 depicts satellite communication signal receiver 38 and satellite antenna 20 as components which may be mounted to any portion of vehicle 10, it should be understood that in other examples, satellite communication signal receiver 38 and satellite antenna 20 may be mounted to, or within housing 28. In still other embodiments, electronic processing device 30 executing appropriate software may serve as satellite communication signal receiver 38.

Electronic processing device 30 is also communicatively connected via lead or bus 40 to a wireless communication signal transceiver 42 which, in turn, is connected to a wireless communication signal antenna 44. Wireless communication signal antenna 44 is configured to receive wireless communication signals and may take any suitable shape or form. Wireless communication signal transceiver 42 is configured to receive wireless communication signals and may be further configured to demodulate the wireless communication signals and then forward the demodulated signal to electronic processing device 30. Wireless communications signal transceiver 42 is further configured to transmit wireless communication signals. Wireless communication signal transceiver 42 is configured to communicate with local portable wireless devices and to obtain satellite related data from such local portable wireless devices. Electronic processing device 30 controls wireless communication signal transceiver 42 to scan for wireless communication signals. Wireless communication signal transceiver 42 is further configured to forward the satellite related data to electronic processing device 30.

In some embodiments, housing 28 further includes a docking port 46. Docking port 46 is communicatively connected to electronic processing device 30 and may be configured to receive a wired connection to a portable wireless device, such as a cellular telephone, a PDA or a portable GPS device. Docking port 46 may have any suitable shape and may be compatible with any type of connector including, but not limited to, USB connectors, Ethernet connectors and telephone connectors. Through docking port 46, a user may connect a portable wireless device to the satellite navigation device 26 via a wired connection. In this manner, satellite navigation device 26 may receive satellite related data through a wired connection.

Although FIG. 2 illustrates wireless communication signal transceiver 42 and wireless communication signal antenna 44 as separate components which may be mounted to any portion of vehicle 10, it should be understood that in other embodiments, wireless communication signal transceiver 42 and wireless communication signal antenna 44 may be mounted to, or within, housing 28. In still other embodiments, electronic processing device 30 executing appropriate software may enable electronic processing device 30 to serve as wireless communication signal transceiver 42. In still other embodiments, a separate wireless communication signal receiver and transmitter may be employed. In still other embodiments, only a receiver may be employed.

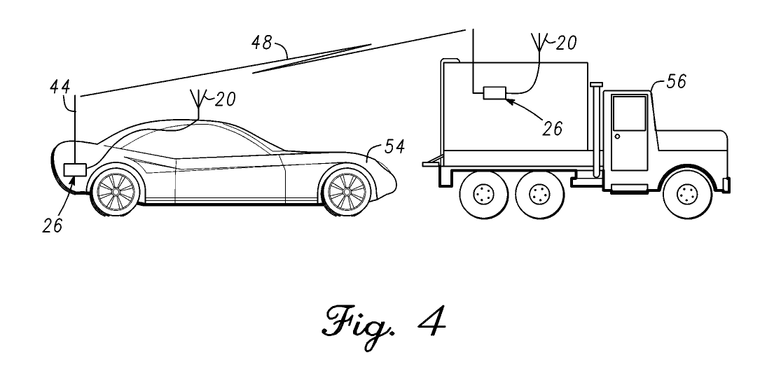

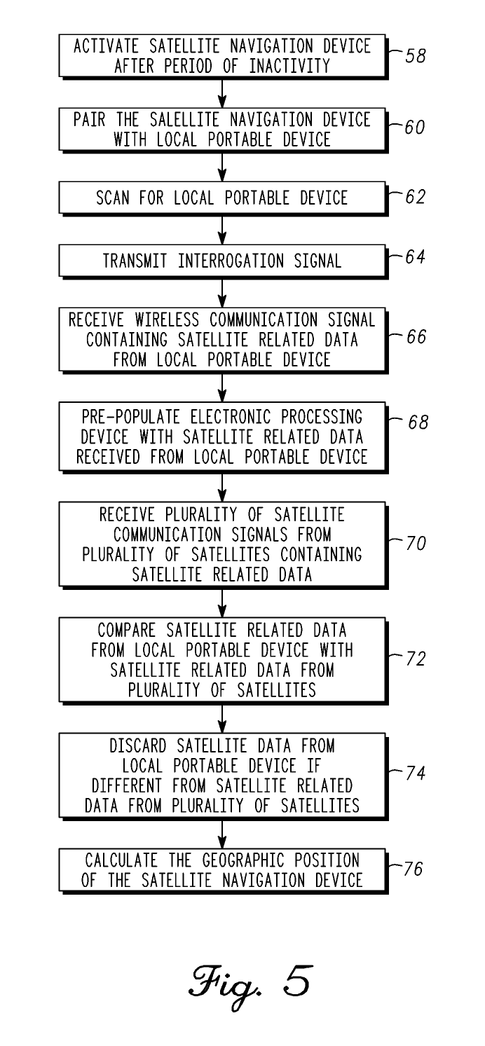

With respect to FIGS. 3 and 4, two exemplary implementations of satellite navigation device 26 are illustrated. FIG. 3 illustrates satellite navigation device 26 receiving satellite related data from a local portable wireless device, while FIG. 4 illustrates satellite navigation device 26 receiving satellite related data from another vehicle.

With respect to FIG. 3, satellite navigation device 26 is depicted receiving a wireless communication signal 48 from a local portable wireless device 50. Wireless communication signal 48 contains satellite related data. In the illustrated implementation, local portable wireless device is in the possession of a pedestrian 52 who is walking in the proximity of vehicle 10. In some implementations, local portable wireless device 50 may be configured to continuously or periodically transmit wireless communication signal 48. In such implementations, satellite navigation device 26 may scan for wireless communication signal 48 when activated after having been switched off for a period of time longer than the ephemeris data update interval. When wireless communication signal 48 is detected, satellite navigation device 26 may receive satellite related data from local portable wireless device 50 so that the satellite navigation device 26 is not required to download the same information from the satellite communication signals 18 prior to determining its geographic position.

In some implementations, Satellite navigation device 26 may begin to acquire satellite communication signal 18 and may begin to receive satellite related data from satellites 16 while simultaneously scanning for wireless communication signals. When satellite navigation device 26 detects local portable wireless device 50, satellite navigation device 26 may, in one implementation, discontinue receipt of satellite related data from satellites 16. Alternatively, in other implementations, satellite navigation device 26 may continue to receive the satellite related data from satellites 16 while simultaneously receiving satellite related data from local portable wireless device 50. This protocol permits satellite navigation device 26 to confirm the accuracy of the satellite related data received from local portable wireless device 50 by checking it against the satellite related data received from satellites 16.

In other implementations, local portable wireless devices 50 may not periodically or continuously transmit wireless communication signal 48. Rather, local portable wireless devices 50 may transmit wireless communication signal 48 only in response to a request or an interrogation seeking such information. In such implementations, satellite navigation device 26 may transmit a wireless communication signal interrogating portable wireless devices in the vicinity of satellite navigation device 26. Local wireless portable device 50 may scan for such interrogation signals and may transmit wireless communication signal 48 containing satellite related data in response to receiving such an interrogation.

In yet another implementation, satellite navigation device 26 may be paired with a specific portable wireless device and may be configured to receive satellite related data only from that device or from other devices with which satellite navigation device 26 has been paired. In an example, a driver may pair a cellular telephone with satellite navigation device 26. When the driver enters and activates vehicle 10 after having been switched off for a period of time exceeding the ephemeris data update interval, satellite navigation device 26 may begin to acquire satellite communication signals 18 from satellites 16 and may simultaneously transmit a wireless communication signal interrogation to determine if any paired local portable wireless devices are available. If the driver's cellular telephone is turned on, it will respond to the interrogation and satellite navigation device 26 communicates with the cellular telephone to obtain the satellite related data.

With respect to FIG. 4, another non-limiting implementation is illustrated. In this implementation, a first vehicle 54 equipped with satellite navigation device 26 is turned on after a period of inactivity exceeding the ephemeris data update interval. A second vehicle 56, travelling ahead of first vehicle 54, is also equipped with a satellite navigation device 26. In this example, second vehicle 56 has been continuously operating for a period of time sufficient to allow the satellite navigation device 26 in second vehicle 56 to obtain satellite related data. In this implementation, satellite navigation device 26 in first vehicle 54 obtains the satellite related data from the satellite navigation device 26 in second vehicle 56.

In one example, the satellite navigation device 26 in second vehicle 56 may continuously transmit the satellite related data. In another example, first vehicle 54 may continuously or periodically transmit an interrogation signal and second vehicle 56 may transmit the satellite related data in response to such interrogation.

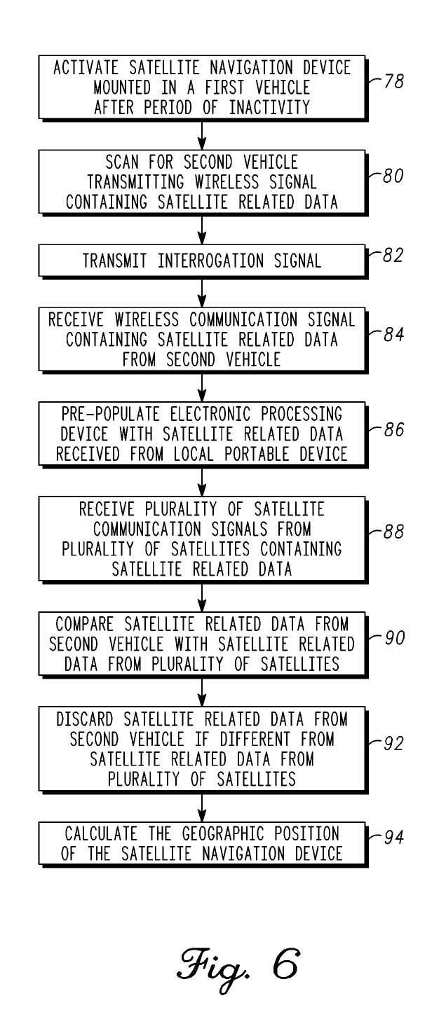

With respect to FIGS. 5 and 6, flow charts are presented illustrating the various steps of non-limiting methods for determining a geographic position. With respect to FIG. 5, a non-limiting method is presented that illustrates an example of a process for determining a geographic position using satellite related data received from a local portable wireless device. At step 58, satellite navigation device 26 is switched on or activated after a period of time exceeding the ephemeris data update interval. In other examples, the system may require current satellite related data after a greater or shorter period of time.

At step 60, satellite navigation device 26 is paired with local portable wireless device 50 in implementations where such pairing is required or permitted. In some implementations, this pairing may only need to occur once. In other implementations, the pairing may need to occur periodically or every time one or both devices have been switched off.

At step 62, satellite navigation device 26 scans for local portable wireless device 50. In implementations where a prior pairing has occurred between satellite navigation device 26 and local portable wireless device 50, satellite navigation device 26 may scan only for the local portable wireless device (or devices) 50 to which it has previously been paired. In other implementations, satellite navigation device 26 scans for any local portable wireless device 50.

At step 64, satellite navigation device 26 transmits a wireless communication signal interrogating for local portable wireless device 50. This step may be performed either in conjunction with, or in lieu of, scanning step 62.

At step 66, satellite navigation device 26 receives wireless communication signal 48 containing satellite related data from local portable wireless device 50. At the time that satellite navigation device 26 receives wireless communication signal 48, satellite navigation device 26 may simultaneously be receiving satellite communication signal 18 from satellites 16. In some implementations, satellite navigation device 26 may discontinue receipt of satellite related data from satellites 16. In other implementations, satellite navigation device 26 may continue to receive satellite communication signal 18.

At step 68, electronic processing device 30 executes various software sub-routines to pre-populate the electronic processing device 30 with the satellite related data received from the local portable wireless device 50. This may include calculating the approximate location and time of the satellite navigation device 26 using the information received from the local portable wireless device 50.

At step 70, satellite navigation device 26 may continue to receive satellite communication signals 18 containing the satellite related data from a plurality of satellites 16. In some circumstances, satellite navigation device 26 may have received the satellite related data from local portable wireless device 50 before acquiring any satellite communication signal 18. In both cases, device 26 will acquire and track the timing part of the satellite signal 18. In the latter case, satellite navigation device 26 may first receive the plurality of satellite communication signals 18 after having calculated its approximate geographic position and time and having pro-populated the electronic processing device 26 with satellite navigation data.

At step 72, electronic processing device 30 may compare the satellite related data supplied by local portable wireless device 50 with the satellite related data supplied by satellites 16 as a validation step. In this case, at step 74, if electronic processing device 30 determines that there is a discrepancy between the satellite related data supplied by satellites 16 and satellite related data supplied by local portable wireless device 50, the satellite related data supplied by local portable wireless device 50 may be discarded. At step 76, the geographic position of satellite navigation device 26 is calculated by using the satellite navigation data received from the satellite signals or from the portable wireless device 50 and timing/ranging information from the satellite signals.

With respect to FIG. 6, a non-limiting method is presented that illustrates an example of a process for determining a geographic position using satellite related data received from a second vehicle. At step 78, satellite navigation device 26 in first vehicle 54 is switched on or activated after a period of time greater than the ephemeris data update interval. In other examples, the system may require current satellite related data after a greater or shorter period of time.

At step 80, satellite navigation device 26 scans for second vehicle 56 equipped with a satellite navigation device 26 transmitting satellite related data. In other implementations, second vehicle 56 may passively await an interrogation signal transmitted by first vehicle 54, the interrogation signal alerting second vehicle 56 that first vehicle 54 requires satellite related data. This is illustrated at step 82 and may be performed in conjunction with, or in lieu of, scanning step 80.

At step 84, satellite navigation device 26 receives wireless communication signal 48 containing satellite related data from second vehicle 56. At the time that satellite navigation device 26 receives wireless communication signal 48, satellite navigation device 26 may simultaneously be receiving satellite communication signal 18 from satellites 16. In some implementations, satellite navigation device 26 may discontinue receipt of satellite related data from satellites 16. In other implementations, satellite navigation device 26 may continue to receive the satellite related data from satellites 16.

At step 86, electronic processing device 30 executes various software sub-routines to pre-populate the electronic processing device 30 with the satellite related data received from second vehicle 56. This may include calculating the approximate location and time of the satellite navigation device 26 using the information received from second vehicle 56.

At step 88, satellite navigation device 26 may continue to receive satellite communication signals 18 from a plurality of satellites 16. In some circumstances, satellite navigation device 26 may have received satellite related data from second vehicle 56 before acquiring any satellite communication signal 18. In that case, satellite navigation device 26 may first receive the plurality of satellite communication signals 18 after having calculated its geographic position.

At step 90, electronic processing device 30 may compare the satellite related data supplied by second vehicle 56 with the satellite related data supplied by satellites 16 as a validation step. In this case, at step 92, if electronic processing device 30 determines that there is a discrepancy between satellite related data supplied by satellites 16 and satellite related data supplied by second vehicle 56, the satellite related data supplied by second vehicle 56 may be discarded. At step 94, the geographic position of satellite navigation device 26 is calculated by using the satellite navigation data received from the satellite signals or from the second vehicle 56 and timing/ranging information from the satellite signals.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. A method for determining a geographic position, the method comprising:
activating a satellite navigation device configured to receive a plurality of satellite communication signals from a respective plurality of satellites and to receive a wireless communication signal;
receiving the wireless communication signal from a local portable wireless device with the satellite navigation device, the wireless communication signal containing satellite related data; and
calculating, with the satellite navigation device, the geographic position of the satellite navigation device using the satellite related data from the local portable wireless device.

2. The method of claim 1, further comprising pairing the satellite navigation device with the local portable wireless device.

3. The method of claim 1, further comprising scanning, with the satellite navigation device, for the wireless communication signal containing the satellite related data transmitted by the local portable wireless device.

4. The method of claim 1, further comprising transmitting a second wireless communication signal with the satellite navigation device to interrogate the local portable wireless device.

5. The method of claim 1, further comprising:
receiving, with the satellite navigation device, the plurality of satellite communication signals from the respective plurality of satellites, the plurality of satellite communication signals containing the satellite related data;
comparing, with the satellite navigation device, the satellite related data received from the local portable wireless device with the satellite related data received from the plurality of satellites;
discarding the satellite related data from the local portable wireless device when the satellite related data from the local portable wireless device differs from the satellite related data from the plurality of satellites; and
calculating, with the satellite navigation device, the geographic position of the satellite navigation device using the satellite related data from the plurality of satellites.

6. A method for determining a geographic position, the method comprising:
activating a satellite navigation device mounted in a first vehicle, the satellite navigation device being configured to receive a plurality of satellite communication signals from a respective plurality of satellites and to receive a wireless communication signal;
receiving the wireless communication signal from a second vehicle with the satellite navigation device, the wireless communication signal containing satellite related data; and
calculating, with the satellite navigation device, the geographic position of the satellite navigation device using the satellite related data from the second vehicle.

7. The method of claim 6, further comprising scanning with the satellite navigation device for the wireless communication signal containing the satellite related data transmitted by the second vehicle.

8. The method of claim 6 wherein the method further comprises transmitting the second wireless communication signal with the satellite navigation device to interrogate the second vehicle.

9. The method of claim 6, further comprising:
receiving, with the satellite navigation device, the plurality of satellite communication signals from the respective plurality of satellites, the plurality of satellite communication signals containing the satellite related data;
comparing, with the satellite navigation device, the satellite related data received from the second vehicle with the satellite related data received from the plurality of satellites;
discarding the satellite related data from the second vehicle when the satellite related data from the local portable wireless device differs from the satellite related data from the plurality of satellites; and
calculating, with the satellite navigation device, the geographic position of the satellite navigation device using the satellite related data from the plurality of satellites.

10. A satellite navigation device for determining a geographic position, the satellite navigation device comprising:
a housing;
an electronic processing device mounted within the housing and configured to calculate the geographic position of the satellite navigation device using satellite related data;
a satellite communication signal receiver communicatively coupled to the electronic processing device and configured to receive a plurality of satellite communication signals from a respective plurality of satellites, the plurality of satellite communication signals containing the satellite related data; and
a wireless communication signal receiver communicatively coupled to the electronic processing device and configured to receive a wireless communication signal containing the satellite related data,
wherein the electronic processing device is configured to calculate the geographic position of the satellite navigation device using the satellite related data contained in the wireless communication signal.

11. The satellite navigation device of claim 10, wherein the satellite related data is ephemeris data.

12. The satellite navigation device of claim 10, wherein the electronic processing device is configured to control the wireless communication signal receiver to scan for wireless communication signals.

13. The satellite navigation device of claim 10, further comprising a wireless communication signal transmitter and wherein the electronic processing device is further configured to control the wireless communication signal transmitter to transmit an interrogation signal.

14. The satellite navigation device of claim 10, wherein the wireless communication signal receiver is configured to receive RF signals

15. The satellite navigation device of claim 10, wherein the wireless communication signal receiver is configured to receive Blue Tooth signals.

16. The satellite navigation device of claim 10, wherein the wireless communication signal receiver is configured to receive DSRC signals.

17. The satellite navigation device of claim 10, wherein the housing includes a port to receive a connector and wherein the port is communicatively connected to the electronic processing device whereby the satellite navigation device is able to receive the satellite related data through a wired connection to a portable wireless device.

18. The satellite navigation device of claim 10, wherein the wireless communication signal receiver is configured to receive the wireless communication signal from a local portable wireless device.

19. The satellite navigation device of claim 18, wherein the electronic processing device is configured to be paired with the local portable wireless device.

20. The satellite navigation device of claim 10, wherein the wireless communication signal receiver is configured to receive the wireless communication signal from a vehicle.
